(19) United States
(12) Patent Application Publication
(10) Pub. No.: US 2022/0097800 A1
(43) Pub. Date: Mar. 31, 2022

(54) Wheel Mounted Multi Axis Drive Mechanism for Unicycle, Bicycle and Reverse Trikes

(71) Applicant: Ravi Shankar Gautam, Gaya (IN)

(72) Inventor: Ravi Shankar Gautam, Gaya (IN)

(21) Appl. No.: 17/421,825

(22) PCT Filed: Jan. 10, 2020
(86) PCT No.: PCT/IN2020/050034

§ 371 Date: Jul. 9, 2021

(30) Foreign Application Priority Data
Jan. 10, 2019 (IN) 201921001279
Jan. 10, 2019 (IN) 202023001105

(51) Int. Cl. B62M 11/02; B62K 1/00; B62K 3/00; B62K 5/08; F16H 1/28

(52) U.S. Cl. CPC B62M 11/02; B62K 1/00; F16H 1/28; B62K 5/08; B62K 3/00

(57) ABSTRACT

This patent discloses drive mechanism which facilitates the usage of multiple planetary gears of enhanced pivoted-slewing-bearing-epicyclic-gear, on both sides of the driving wheel of bicycle, reverse trike and unicycle to drive the wheel, thereby facilitating application of driving force on larger area. Mechanism helps in drawing more power from the rider efficiently. Helps to provide more restraining support to the wheel, thereby reduce the wobbling of the wheel. Additional arrangement is provided which facilitates syncing of pedals during reverse pedaling while allowing driving wheel to coast. Additionally the said mechanism also provides anti-tipping cum braking mechanism in unicycle.

### FIELD OF INVENTION

This application is about improving wheel mounted drive mechanism for unicycle, bicycle and reverse trike described in Indian patent application No. 201821007902 and Indian patent application No. 201821007903 to facilitate multi-axis drive mechanism.

### BACKGROUND OF INVENTION

Avoiding the usage of fossil fuel or dependence on any other external source of energy for personal transport has been a priority. Invention of personal transport vehicle like bicycle was significant step in this direction. On one hand in order to have more comfort in terms of stability reverse trike was invented and on the other hand in order to reduce its size and more portable to be carried as a luggage to far off places foldable bicycle, unicycle and half bikes were invented. In my patent applications Indian patent application No. 201821007902 and Indian patent application No. 201821007903 I have described wheel mounted drive mechanism for unicycle, bicycle and reverse trikes which is more efficient than previous inventions in the sense that former can provide gear ratio without using chain drive.

### Technical Problem

One of the drawbacks of the prior art for wheel mounted drive mechanism for unicycle, bikes and reverse trikes is that it doesn't provide multi axis drive mechanism.

One of the drawbacks of the prior art of unicycle is that we need to make additional arrangement like Gyroscope to prevent tipping off in case of unicycle. In my previous patent application, Indian patent application No. 201821007902, I have described the reverse torque braking system. Rider will need to apply the brake in the event of tipping off.

### SUMMARY OF INVENTION

One of the objectives is to provide drive system which facilitates the usage of multiple planetary gears, on both sides of the driving wheel of bicycle, reverse trike and unicycle, to drive the wheel, thereby facilitating application of driving force on larger area. Mechanism helps in drawing more power from the rider efficiently. Additionally improved form of wheel mounted pivoted-slewing-bearing-epicyclic-gear, is mounted to driving wheel in an arrangement to facilitate syncing of pedals during reverse pedaling while allowing driving wheel to coast.

The drive mechanism, according to this invention, also helps to provide more restraining support to the wheel, thereby reduce the wobbling of the wheel.

Additionally the said mechanism also provides anti-tipping cum braking mechanism for unicycle.

### BRIEF DESCRIPTION OF DRAWINGS

FIG. 1, FIG. 2 and FIG. 3 Wheel Mounted Multi Axis Drive Mechanism, according to this invention, is shown to be assembled on two sides of driving wheel of unicycle, bicycle and reverse trike, respectively.

FIG. 4 and FIG. 5 Closeup view of Wheel Mounted Multi Axis Drive Mechanism mounted on unicycle and bicycle (and reverse trike), respectively.

FIG. 6 Enhanced pivoted-slewing-bearing-epicyclic-gear.

FIG. 7 and FIG. 8 Multi gear engagement system and wheel, respectively.

FIG. 9 Steerer rod of unicycle with spacer.

FIG. 10 Variation of internal driving spur gear rail and external driving spur gear rail

FIG. 11 and FIG. 12 Operation of Wheel Mounted Multi Axis Drive Mechanism.

### DESCRIPTION OF EMBODIMENTS

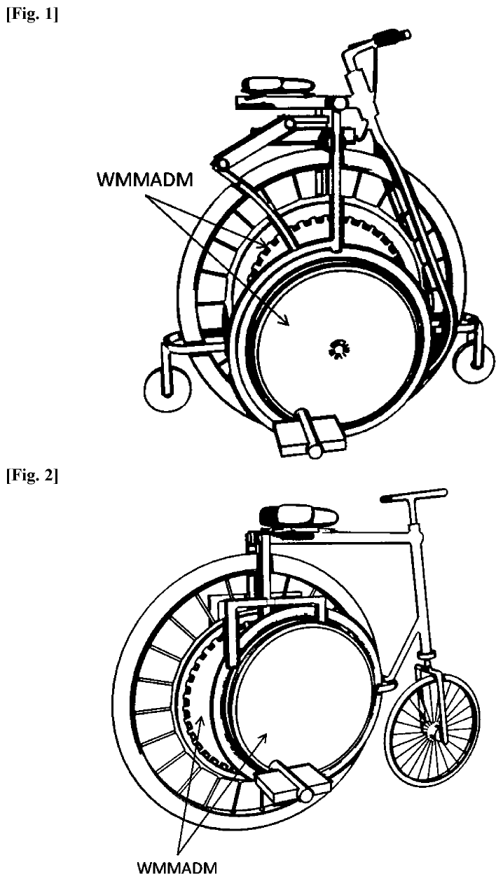

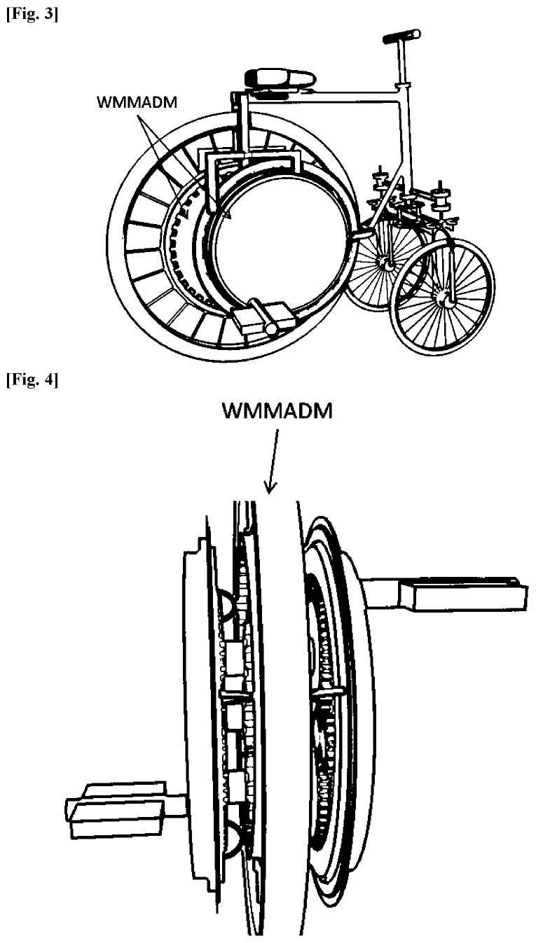

Referring to [FIG. 1], [FIG. 2] and [FIG. 3] the preferred embodiment of Wheel Mounted Multi Axis Drive Mechanism (WMMADM) according to this invention is shown to be assembled on two sides of driving wheel of unicycle, bicycle and reverse trike.

Wheel Mounted Multi Axis Drive Mechanism (WMMADM), as shown in [FIG. 1] and [FIG. 2], according to this invention, comprises a multi gear engagement system (MGES) and a pair of enhanced pivoted-slewing-bearing-epicyclic-gear (ESBE) each assembled on either side of driving wheel.

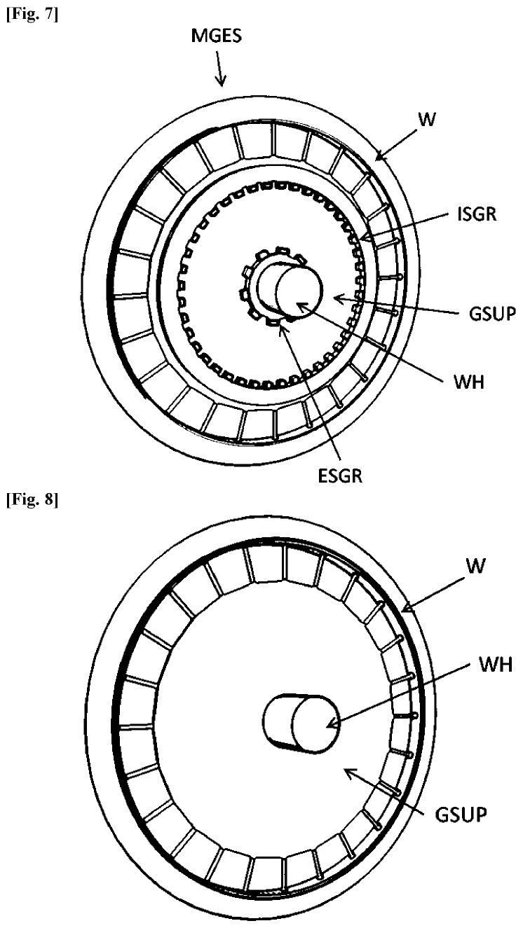

Multi gear engagement system (MGES), as shown in [FIG. 7] and [FIG. 8], comprises a wheel (W), a pair of internal driving spur gear rail (ISGR), a pair of external driving spur gear rail (ESGR), mounted on corresponding side of driving wheel wherein
wheel (W), have a coaxial annular disk, namely gear support, (GSUP), fixedly mounted on its hub (WH) which on its periphery is connected to the rim via spokes;
an internal driving spur gear rail (ISGR) is internally teethed spur gear of radius (approximately) equal to the radius hub planetary gear of enhanced pivoted-slewing-bearing-epicyclic-gear (ESBE) and coaxially fixedly mounted on one side of said gear support, (GSUP);
an external driving spur gear rail (ESGR) is externally teethed spur gear of radius (appropriately) greater than the distance between hub planetary gear and one of the other two planetary gears of enhanced pivoted-slewing-bearing-epicyclic-gear (ESBE) and coaxially fixedly mounted on one side of said gear support, (GSUP).

Enhanced-pivoted-slewing-bearing-epicyclic-gear, (ESBE), is an improved form of wheel mounted pivoted-slewing-bearing-epicyclic-gear, (SBE), to allow it to be used as multi-axis drive system which can be assembled with multi-gear engagement system, (MGES), to produce a rotating motion to the wheel and facilitate application of driving force on large area. Additionally improved form of wheel mounted pivoted-slewing-bearing-epicyclic-gear, is mounted to driving wheel in an arrangement to facilitate syncing of pedals during reverse pedaling while allowing driving wheel to coast.

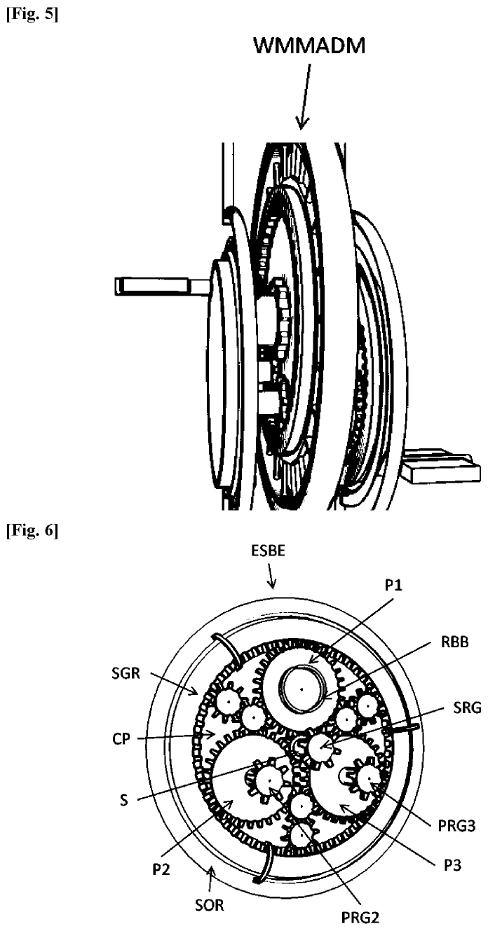

Enhanced-pivoted-slewing-bearing-epicyclic-gear, (ESBE), comprises of three far planet gears, three satellite gears, three planetary gears, one sun gear, one carrier plate and one internally teethed slewing bearing assembled according to wheel mounted pivoted-slewing-bearing-epicyclic-gear, (SBE), which includes, as shown in [FIG. 6], three planetary gears, (P1), (P2), and (P3), being journalled to a carrier plate at the vertex of an equilateral triangle having incenter same as center of the carrier plate (CP), and meshingly engaged with gear ring (SGR), of internal toothed slewing bearing coaxial to the carrier plate, sun gear (S) being coaxially journalled to the center of carrier plate (CP) meshingly engaged with three planetary gears and one of the planetary gears, (P1), here onwards to be referred as hub planetary gear, is coaxially mounted with clockwise oriented ratchet ball bearing, (RBB), with the improvement being
hub planetary gears of two enhanced pivoted-slewing-bearing-epicyclic-gear (ESBE) are connected at their centers via axle which in turn is coaxially internally journalled via ball bearing to the hub shell of the hub of the driving wheel (W);
ratchet ball bearing, (RBB), is fixedly externally coaxially mounted on each of the two ends of the hub shell of hub of the driving wheel;
outer race of above mentioned ratchet ball bearing is either coaxially directly connected to designated planetary gears of drive systems of Wheel Mounted Multi Axis Drive Mechanism at corresponding side via coupler like, but not limited to, jaw flex coupler, or is coaxially connected to the corresponding end of the axle of the hub of the driving wheel (W) over bridging other parts of the hub;
each of the other two planetary gears, (P2) and (P3), have a clockwise oriented ratchet gear, (PRG2) and (PRG3), respectively, referred to as planetary ratchet gears, coaxially mounted on its face;
sun gear (S) have an anticlockwise oriented ratchet gear, (SRG), referred to as sun ratchet gear, coaxially mounted on its face.

Each of the pair of enhanced-pivoted-slewing-bearing-epicyclic-gear (ESBE), as shown in [FIG. 1], [FIG. 2] and [FIG. 3], is mounted on one side of wheel of multi gear engagement system, (MGES), by attaching the outer ring of slewing bearing (SOR) to the frame, such that hub planetary gear, (P1), mounted to corresponding side of hub (WH) of the driving wheel such that sun ratchet gear is meshingly engaged with external driving spur gear rail; planetary ratchet gears, (PRG2) and (PRG3) are meshingly engaged with internal driving spur gear rail (ISGR).

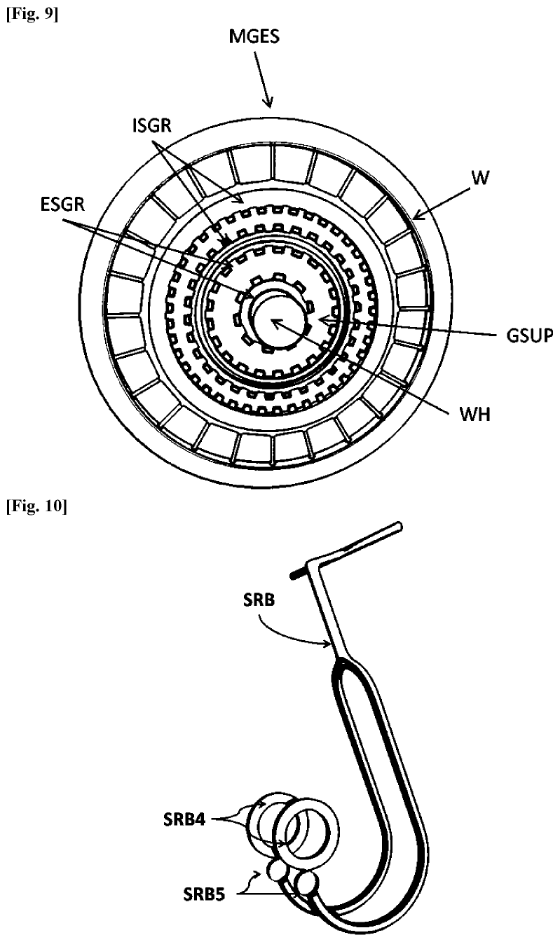

Steerer rod (SRB) of unicycle, as shown in [FIG. 9], is modified to have a hole in the form of bearing spacer (SRB5), located below hub bearing (SRB4) for the steerer rod, through which axis of sun ratchet gear (SRG), can rotatably pass through. Note that axis of sun ratchet gear (SRG), and steerer rod are rigidly attached.

In one of the variation for the case when difference between radii of two spur gear rails, namely internal driving spur gear rail (ISGR) and external driving spur gear rail (ESGR), is large enough, then both spur gear rails may comprise, as shown in [FIG. 10], a pair of concentric spur gears having appropriate radial distance wherein
one with larger radius being internally teethed and one with smaller radius being externally teethed;
in case of internal driving spur gear rail (ISGR), externally toothed spur gear is coaxially journalled to the wheel via ball bearing (so that it is freely rotatable) and internally teethed spur gear coaxially fixedly mounted on the gear support (GSUP);
in case of external driving spur gear rail (ESGR), internally toothed spur gear is coaxially journalled to the wheel via ball bearing (so that it is freely rotatable) and externally teethed spur gear coaxially fixedly mounted on the gear support (GSUP).

In one of the variation, satellite gears and far planet gears of enhanced-pivoted-slewing-bearing-epicyclic-gear (ESBE) may also be engaged with appropriate gear rail of appropriate radius mounted on gear support, (GSUP), of multi gear engagement system (MGES), via appropriate ratchet gear and components including steerer rod of unicycle may be appropriately modified to accommodate the passage of axes of ratchet gears.

### Drive Mechanism Operation

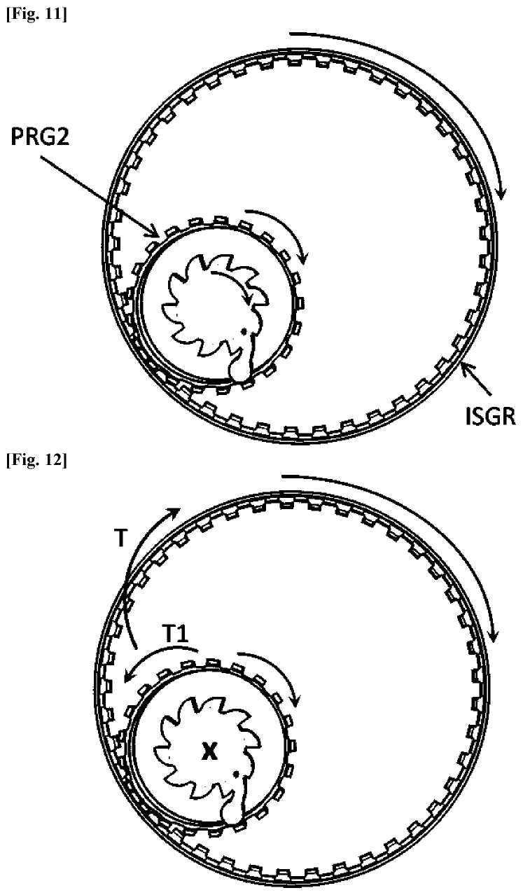

In case of unicycle or bicycle or reverse trike, while the rider is pedaling, as shown in [FIG. 11], ratchet of ratchet gear (PRG2) rotates in clockwise direction and forces the pawl, and therefore its externally toothed spur gear, of the ratchet gear (PRG2) to rotate in clockwise direction. Clockwise rotation of spur gear of ratchet gear (PRG2) causes clockwise rotation of with internal driving spur gear rail (ISGR) and therefore causes rotation of the wheel.

In case unicycle or bicycle or reverse trike is in motion, and the rider is not pedaling, as shown in [FIG. 12], ratchet of ratchet gear (PRG2) is stationary and externally toothed spur gear, of the ratchet gear (PRG2) keeps rotating in clockwise direction while pawl slips on the tooth of the ratchet of ratchet gear (PRG2).

In case of unicycle while rider is not pedaling, in the event of tipping off towards the front side, as indicated by arrow (T) in [FIG. 12], the enhanced-pivoted-slewing-bearing-epicyclic-gear (ESBE) will tend to rotate about hub planetary gear in clockwise direction which in turn will cause spur gear of ratchet gear (PRG2) to rotate in anti-clockwise, indicated by arrow (T1), which will be opposed by its clockwise rotation (caused due to internal driving spur gear rail (ISGR)). Additionally anti-clockwise rotation of spur gear of ratchet gear (PRG2) will be stopped by stationary (indicated by cross mark) ratchet of ratchet gear (PRG2) via pawl. Thus enhanced-pivoted-slewing-bearing-epicyclic-gear (ESBE) works as anti-tipping cum braking mechanism for unicycle.

### Syncing of Pedals

In the event of forward pedaling (designated) hub planetary gear will force driving wheel to rotate via ratchet ball bearing and both the pedals will be in sync. In the event of reverse pedaling, driving wheel will be allowed to coast but since the (designated) hub planetary gears are connected via axle reverse rotation of pedal of one side will cause reverse rotation of pedal on other side thereby syncing the two pedals. Since the axle is internally journalled to hubshell via ball bearing, it will (in addition to ratchet ball bearing (RBB)) also allow driving wheel to coast during reverse pedaling or no pedaling.

1. Wheel Mounted Multi Axis Drive Mechanism assembled on two sides of driving wheel of unicycle, bicycle and reverse trike which, by appropriately using multiple planetary gears and sun gear, can facilitate
a. application of driving force on larger area and minimize wobbling of driving wheel
b. syncing of pedals during reverse pedaling while allowing driving wheel to coast
c. provide unicycle anti-tipping cum braking mechanism.

2. Wheel Mounted Multi Axis Drive Mechanism, claimed in [claim 1], comprises a multi gear engagement system and a pair of enhanced pivoted-slewing-bearing-epicyclic-gear each assembled on either side of driving wheel.

3. Multi gear engagement system, claimed in [claim 2], comprises a wheel, a pair of internal driving spur gear rail, a pair of external driving spur gear rail, mounted on corresponding side of driving wheel wherein
wheel have a coaxial annular disk, namely gear support, fixedly mounted on wheel's hub which on its periphery is connected to the rim of the wheel via spokes;
an internal driving spur gear rail is internally teethed spur gear of radius (approximately) equal to the radius hub planetary gear of enhanced pivoted-slewing-bearing-epicyclic-gear (to be explained in [claim 5]) and coaxially fixedly mounted on one side of said gear support;
an external driving spur gear rail is externally teethed spur gear of radius (appropriately) greater than the distance between hub planetary gear and one of the other two planetary gears of enhanced pivoted-slewing-bearing-epicyclic-gear (to be explained in [claim 5]) and coaxially fixedly mounted on one side of said gear support.

4. Enhanced-pivoted-slewing-bearing-epicyclic-gear, claimed in [claim 2], is an improved form of wheel mounted pivoted-slewing-bearing-epicyclic-gear to allow it to be used as multi-axis drive system which can be assembled with multi-gear engagement system, claimed in [claim 3], to produce a rotating motion to the wheel and facilitate application of driving force on large area.

5. Enhanced-pivoted-slewing-bearing-epicyclic-gear, claimed in [claim 2] and [claim 4], comprises of three far planet gears, three satellite gears, three planetary gears, one sun gear, one carrier plate and one internally teethed slewing bearing assembled according to wheel mounted pivoted-slewing-bearing-epicyclic-gear which includes, three planetary gears being journalled to a carrier plate at the vertex of an equilateral triangle having incenter same as center of the carrier plate and meshingly engaged with gear ring of internal toothed slewing bearing coaxial to the carrier plate, sun gear being coaxially journalled to the center of carrier plate meshingly engaged with three planetary gears and one of the planetary gears, here onwards to be referred as hub planetary gear, is coaxially mounted with clockwise oriented ratchet ball bearing with the improvement, claimed in [claim 4], being
hub planetary gears of two enhanced pivoted-slewing-bearing-epicyclic-gear are connected at their centers via axle which in turn is coaxially internally journalled via ball bearing to the hub shell of the hub of the driving wheel;
ratchet ball bearing is fixedly externally coaxially mounted on each of the two ends of the hub shell of hub of the driving wheel;
outer race of above mentioned ratchet ball bearing is either coaxially directly connected to designated planetary gears of drive systems of Wheel Mounted Multi Axis Drive Mechanism at corresponding side via coupler like, but not limited to, jaw flex coupler, or is coaxially connected to the corresponding end of the axle of the hub of the driving wheel over bridging other parts of the hub;
each of the other two planetary gears have a clockwise oriented ratchet gear, referred to as planetary ratchet gears, coaxially mounted on its face;
sun gear have an anticlockwise oriented ratchet gear, referred to as sun ratchet gear, coaxially mounted on its face.

6. Each of the pair of enhanced-pivoted-slewing-bearing-epicyclic-gear, claimed in [claim 2], [claim 4] and [claim 5], is mounted on one side of wheel of multi gear engagement system, claimed in [claim 2] and [claim 3], by attaching the outer ring of slewing bearing to the frame, such that hub planetary gear, mentioned in [claim 5], mounted to corresponding side of hub of the driving wheel such that sun ratchet gear is meshingly engaged with external driving spur gear rail; planetary ratchet gears, mentioned in [claim 5] are meshingly engaged with internal driving spur gear rail.

7. Steerer rod of unicycle is modified to have a hole in the form of bearing spacer located below hub bearing for the steerer rod, through which axis of sun ratchet gear can rotatably pass through.

8. In one of the variation, for the case when difference between radii of two spur gear rails, namely internal driving spur gear rail and external driving spur gear rail, claimed in [claim 3], is large enough, then both spur gear rails may comprise a pair of concentric spur gears having appropriate radial distance wherein
one with larger radius being internally teethed and one with smaller radius being externally teethed;
in case of internal driving spur gear rail, externally toothed spur gear is coaxially journalled to the gear support via ball bearing (so that it is freely rotatable) and internally teethed spur gear coaxially fixedly mounted on the gear support;
in case of external driving spur gear rail, internally toothed spur gear is coaxially journalled to the gear support via ball bearing (so that it is freely rotatable) and externally teethed spur gear coaxially fixedly mounted on the gear support.

9. In one of the variation, satellite gears and far planet gears of enhanced-pivoted-slewing-bearing-epicyclic-gear, claimed in [claim 2], [claim 4] and [claim 5], may also be engaged with appropriate gear rail of appropriate radius mounted on gear support of multi gear engagement system, claimed in [claim 2] and [claim 3], via appropriate ratchet gear and further, components including steerer rod of unicycle may be appropriately modified to accommodate the passage of axes of ratchet gears.
